(19) United States
(12) Patent Application Publication
(10) Pub. No.: US 2007/0077335 A1
(43) Pub. Date: Apr. 5, 2007

(54) Process for preparing microwavable vegetables

(76) Inventors: Moez Mohamed Bouraoui, Clifton, NJ (US); Daniel Joseph Kochakji, West Milford, NJ (US); Anna Virginia Marasigan, New City, NY (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 11/243,167

(22) Filed: Oct. 4, 2005

(51) Int. Cl. A23L 1/164

(52) U.S. Cl. 426/241

(57) ABSTRACT

The present invention is directed to a process for making microwavable vegetables. The vegetables are blanched to have a hardness factor of about 10 to 30 kg force. The packaged microwavable vegetables are mixed with sauce and maintain good textural, visual and taste characteristics for about 1 to 2 months after packaging and refrigerating.

### FIELD OF THE INVENTION

The present invention is directed to a process for making refrigerated vegetable dishes that are suitable for heating in a microwave oven. More particularly, the invention is directed to a process for making microwavable dishes comprising the microwavable vegetables by first blanching the vegetables and mixing the same with a cooked sauce. The resulting mixture of vegetables and sauce can be hot packed or heated after packaging. The vegetables of the present invention are homogeneously cooked, and unexpectedly, maintain good textural, visual, and taste characteristics, for about one to two months after packaging and refrigerating, and after being heated for serving.

### BACKGROUND OF THE INVENTION

Many consumers, due to our hectic world, enjoy the convenience of ready-to-serve microwavable foods. Unfortunately, many food products, especially vegetables, are cooked and processed in such a way that during and subsequent to being packaged in a microwavable pack, the food products lose their structural integrity as well as their visual and taste characteristics. Particularly, vegetables, like potatoes, are conventionally treated in such a way that the potato slices are almost reduced to small particulates after being heated in a microwavable package and just prior to serving. In fact, ready-to-heat and eat refrigerated scalloped potatoes that have all the characteristics of freshly made scalloped potatoes are not commercially available.

It is of increasing interest to develop a process for making fresh tasting and ready-to-heat dishes, especially those comprising microwavable vegetables like potatoes. This invention, therefore, is directed to a process for making microwavable vegetables and dishes with the same. The invention comprises the steps of blanching the vegetables and mixing the blanched vegetables with a cooked sauce. The resulting mixture is filled into microwavable packaging and the vegetables unexpectedly maintain good textural, visual and taste characteristics for one to two months after packaging and refrigerating, and after being heated for serving.

### ADDITIONAL INFORMATION

Efforts have been made for preparing vegetable products. In U.S. Application No. 2004/0040427 A1, a cutter blade assembly for cutting vegetable products is described.

Other efforts have been disclosed for preparing vegetable products. In World Application WO 93/02572, natural potato products are described.

Even other efforts have been disclosed for preparing vegetable products. In U.S. Pat. No. 5,750,165, methods for preparing a refrigerated potato product are described.

None of the additional information above describes microwavable dishes with vegetables that maintain good textural, visual and taste characteristics one to two months after packaging and refrigerating, and after being heated for serving.

### SUMMARY OF THE INVENTION

In a first aspect, the present invention is directed to a process for preparing a dish comprising vegetables suitable to microwave and comprising, in no particular order, the steps of:
(a) blanching vegetable at a temperature from about 75° C. to about 125° C. to produce a blanched vegetable;
(b) heating a sauce to a temperature from about 70° C. to about 125° C. to produce a heated sauce; and
(c) combining the blanched vegetable and the heated sauce to produce a mixture either before filling for packaging or during filling for packaging
   wherein the vegetable has a texture from about 10 Kg force to about 30 Kg force after blanching and the temperature of the mixture at the time of filling or after filling is at least 71.11° C. to about 95° C.

In a second aspect, the present invention is directed to the microwavable dish made in the first aspect of this invention.

Vegetable, as used herein, means a plant or portion thereof cultivated for an edible part, including flower buds like broccoli and cauliflower buds. Other illustrative vegetables suitable for use in this invention include carrots, beets, mushrooms, zucchini, and especially, potato.

Texture, as used herein, means firmness in Kg force after blanching vegetable as determined by a Texture Technologies TA XT 2I Texture Analyzer with an Ottawa cell. The texture values obtained are averages based on the average of two (2) to three (3) side-by-side samples (enough samples to cover 49 cm²), each of which has a thickness of about 0.476 cm and an approximate diameter of about 3.8 to about 5.1 cm. The texture is determined with the Ottawa cell plunger (8 cm long shaft, 49 cm² base) that is lowered into the vegetables as they sit side-by-side, stopping 1 mm above a bottom plate supporting the same within the texture analyzer.

Approximate diameter means the diameter of a cross-section of the vegetable whereby the cross-section of the vegetable is not a perfect circle. All diameters and thickness as discussed herein are taken prior to blanching the vegetable.

Sauce as used herein is meant to mean a liquid dressing to be served with food, including a gravy. Combining before filling for packaging means making a mixture of vegetable and sauce first, then filling the mixture into the desired package. Combining during filling for packaging means simultaneously making a mixture and filling the desired package or making the mixture in the desired package by filling the desired package first with sauce or vegetable. Homogeneously cooked means having a similar texture after heating the refrigerated product.

### DETAILED DESCRIPTION OF THE PREFERRED EMBODIMENTS

The only limitation with respect to the type of vegetable used in this invention is that the vegetable is one suitable for human consumption. Illustrative non-limiting examples of the type of vegetable that may be used in this invention include broccoli, cauliflower, carrots, beets, zucchini, potato, mushrooms or mixtures thereof. In a preferred embodiment, the vegetable has an approximate diameter from about 2.5 cm to about 9 cm, and most preferably, from about 3.8 cm to about 5.1 cm, including all ranges subsumed therein.

In an especially preferred embodiment, the vegetable is potato, and most preferably, a Russett Burbank, Russett Narkota, red round, white round, sweet potato, yam, or a mixture thereof.

When preparing the vegetables for the microwavable dish of the present invention, the vegetables are, in no particular order, washed, peeled (if necessary) and sliced. The sliced vegetable is preferably blanched in hot water and/or steam for about 6 to about 20 minutes, and preferably, from about 8 to about 18 minutes, and most preferably, from about 9 to 16 minutes, including all ranges subsumed therein. The temperature at which the blanching takes place is from about 75° C. to about 125° C., and preferably, from about 75° C. to about 105° C., and most preferably, from about 85° C. to about 100° C., including all ranges subsumed therein. Typically, and after slicing, the vegetable has a thickness from about 0.25 cm to about 1 cm, and preferably, from about 0.3 cm to about 0.85 cm, and most preferably, from about 0.32 cm to about 0.64 cm, including all ranges subsumed therein. In a preferred embodiment, the texture of the vegetable after blanching is from about 11 to about 25 kg force, and most preferably, from about 12 to about 20 kg force, including all ranges subsumed therein.

There is no limitation with respect to the type of sauce that may be used in this invention other than that the sauce is suitable to heat and serve with vegetables. Illustrative and non-limiting examples of the type of sauce that may be used in this invention include pesto sauce, alfredo sauce, a tomato-based sauce, hollandaise sauce, cream or dairy-based sauce, cheese sauce, or chicken, beef or fish flavored gravies. Sauces made available by Unilever under the Bertoli, Ragu and Knorr brands are especially preferred.

The sauce (before being combined with vegetable) is typically heated (i.e., cooked) to a temperature from about 70° C. to about 125° C., and preferably, from about 75° C. to about 105° C., and most preferably, from about 80° C. to about 90° C., including all ranges subsumed therein.

When combining before filling for packaging is desired, a mixing vessel for receiving the heated sauce and blanched vegetable may be set up. The same preferable receives vegetable first. The mixing vessel preferably is one which is suitable to gently mix with paddles or arms that turn in a clockwise or counter clockwise direction and rotate from about 2 to about 9, and preferably, from about 3 to 9, and most preferably, from about 4 to about 8 revolutions per minute, including all ranges subsumed therein.

Mixing preferably takes place for about 0.5 minutes to about 3 minutes, and preferably, from about 1 minute to about 1.5 minutes, including all ranges subsumed therein.

The mixing vessel is preferably a ribbon mixer. In an especially preferred embodiment, the ribbon mixer is hot water jacketed. Illustrative examples of the type of mixer suitable for use in this invention include those made commercially available by suppliers like Blentech Corp., RMF and Scott Equipment.

Subsequent to homogeneously mixing the sauce and vegetable, the resulting mixture is preferably gravity fed to a filler having nozzles that have openings from about 2.54 cm to about 7.6 cm, and preferably, from about 3.15 cm to about 6.3 cm, and most preferably, from about 3.8 cm to about 5.5 cm, including all ranges subsumed therein. The filler (which preferably comprises a piston pump) then feeds the sauce and vegetable mixture into desired packaging.

An alternative to the mix then fill process described above is a two stage filling process that simultaneously combines vegetable and sauce during filling into desired packaging or by filling packaging with vegetable, and subsequently, sauce or sauce, and subsequently, vegetable.

Typically, the mixture fed into the packaging (regardless of the method) is from about 30 to about 85 percent, and preferably, from about 40 to about 70 percent, and most preferably, from about 58 to about 68 percent by weight vegetables, including all ranges subsumed therein.

It is also within the scope of this invention to employ optional additives like rice, pasta, pieces or particulates of nuts, fruits, meats (e.g., like, beef, pork, chicken and/or fish) and other vegetable particulates like individually quick frozen onions along with the vegetable and sauce mixtures prepared in this invention.

Other optional additives which may be used in this invention include cheese, dairy ingredients like milk, sour cream, and margarine, and spices (e.g., salt, pepper), flavor enhancers, like monosodium glutamate or kelp, and thickeners like yeast and/or agents such as guar gum, xanthan gum, starches or mixtures thereof. Additives preferred for use in this invention include texturizers like disodium phosphate, preservatives like potassium sorbate, as well as antimicrobial agents with nisin. When optional additives are used, they typically make up less than about 15 percent by weight of the mixture fed into the package.

In a preferred embodiment, the package used in this invention is a glass or polymeric jar, a sachet or a package generally classified as a tub or tray. Such packaging is microwavable and typically suitable for servings of eight or less, and preferably, for one to four servings. In an especially preferred embodiment, the mixture fed to packaging according to this invention is ready-to-heat and microwavable scalloped potatoes. Moreover, at the time of packaging (i.e., via hot packing) or after packaging but while still in production, the sauce and vegetable mixture should be at a temperature from at least about 71.11° C. to about 95° C., and preferably, from about 71.11° C. to about 82° C., including all ranges subsumed therein. If hot packing is not desired, the packaged mixture (preferably immediately after sealing, and while in production), can be heated with, for example, hot water, steam, hot air, microwaves or in an oven. Subsequent to finalizing production, the packaged product is preferably cooled (within about 4 hours) to a temperature from about 1.5° C. to about 5° C., including all ranges subsumed therein.

The examples below are provided to facilitate an understanding of the present invention. The examples are not intended to limit the scope of the claims.

### EXAMPLE 1

Microwavable dishes having scalloped potatoes and a dairy-based sauce were made in the following manner.

First, dairy-based sauces were made by mixing the following ingredients in a mixer and heating the resulting mixtures to about 88° C. to produce heated sauces.

| Ingredient | Percent by Weight* |
|---|---|
| Milk | 13.4 |
| Dairy Components | 12.2 |
| Grated Cheese | 2.3 |
| Starch | 0.6 |
| Preservative | 0.35 |
| Disodium Phosphate | 0.2 |
| IQF Onions | 8.3 |
| MSG | 0.1 |
| Spices | 0.36 |

*based on total weight of sauce and potato

Second, potato was prepared by washing, peeling and slicing Russett Burbank potato into slices having an approximate diameter of about 3.8 cm to 5.1 cm and a thickness of about 0.476 cm. The resulting slices were blanched in steam for about 10 minutes. The blanched potato product had a hardness factor of about 20 kg force. Cooked potatoes and sauces were combined (62% by weight and 38% by weight, respectively) in ribbon mixers having hot water jackets. The resulting potato and sauce mixtures were transferred by gravity to piston fillers where product was hot packed into microwavable tubs (652 grams). The mixtures of vegetable (i.e., potato) and sauce were at a temperature from about 71.7° C. to about 76.6° C. during the filling/hot packing process, and subsequently, sealed and cooled to about 4° C. within about two hours.

### EXAMPLE 2

Sauce was prepared in a manner similar to the one described in Example 1. Sliced potatoes were steamed for about 15 minutes, cooled with water to about 21° C. to about 27° C. then drained. Microwavable tubs were first filled with potato, and subsequently, sauce (62% and 38% by weight, respectively). At the time of filling, the resulting mixtures were at temperatures of less than 71.11° C.; however, the microwavable tubs with mixtures were sealed then heated with steam until the temperature of the mixtures were elevated to about 74° C. The resulting packages were cooled to about 4° C. within about two hours. The cooked potatoes had a hardness factor of about 15 Kg force.

### EXAMPLE 3

The microwavable tubs having scalloped potatoes prepared in Examples 1 and 2 were refrigerated (about 4° C.) for about two (2) months. The tubs were removed from the refrigerator and analyzed for product texture, as well as visual and taste characteristics. All panelists, unexpectedly, concluded (after heating in a microwave oven for about five (5) minutes) that the scalloped potato product looked excellent, and had substantially unblemished potato slices. Also, the panelist unexpectedly concluded that the potatoes were homogeneously cooked and that the product tasted freshly made when tasted and after being heated in the microwave oven.

What is claimed is:

1. A process for preparing a dish comprising vegetables suitable to microwave and comprising, in no particular order,
(a) blanching vegetable at a temperature from about 75° C. to about 125° C. to produce a blanched vegetable;
(b) heating a sauce to a temperature from about 70° C. to about 125° C. to produce a heated sauce; and
(c) combining the blanched vegetable and the heated sauce to produce a mixture either before filling for packaging or during filing for packaging
wherein the vegetable has a texture from about 10 Kg force to about 30 Kg force after blanching and the temperature of the mixture at the time of filling or after filling is at least 71.11° C. to about 95° C.

2. The process according to claim 1 wherein the vegetable is broccoli, cauliflower, carrots, beets, zucchini, mushroom, potato or a mixture thereof.

3. The process according to claim 1 wherein the vegetable is potato.

4. The process according to claim 3 wherein the potato is Russett Burbank, Russett Narkota, red round, white round, sweet potato, yam, or a mixture thereof.

5. The process according to claim 4 wherein the potato has an approximate diameter from about 2.5 to about 9 cm and a thickness from about 0.25 to about 1 cm.

6. The process according to claim 1 wherein the mixture comprises from about 30 to 85 percent by weight vegetable.

7. The process according to claim 1 wherein the temperature of the mixture is from about 71.11° C. to about 82° C.

8. The process according to claim 1 wherein the mixture further comprises rice, pasta, pieces of nuts, fruit, meats, vegetables, cheese, spices, flavor enhancer, gum, starch, preservative, anti-microbial agent or a mixture thereof.

9. The process according to claim 1 wherein the mixture is produced prior to filling packaging and not heated after packaging.

10. The process according to claim 1 wherein the mixture is produced during the filling of packaging and in-pack heated after packaging and sealing.

11. The process according to claim 1 wherein the mixture is packaged and cooled in the package to a temperature from about 1.5 to about 5° C.

12. The microwavable dish comprising microwavable vegetables made by the process of claim 1.
